(19) United States
(12) Patent Application Publication
(10) Pub. No.: US 2025/0315372 A1
(43) Pub. Date: Oct. 9, 2025

(54) CONTROL DEVICE, STORAGE DEVICE, AND COMPUTING SYSTEM

(71) Applicant: SK hynix Inc., Icheon-si (KR)

(72) Inventor: Jin Soo KIM, Icheon-si (KR)

(21) Appl. No.: 18/960,829

(22) Filed: Nov. 26, 2024

(30) Foreign Application Priority Data
Apr. 3, 2024 (KR) 10-2024-0045339
Jul. 17, 2024 (KR) 10-2024-0094084

(51) Int. Cl. G06F 12/02

(52) U.S. Cl. CPC G06F 12/0223

(57) ABSTRACT

A storage device may process a command by loading mapping data into a first memory area of a first auxiliary memory included in the storage device in a first operation mode, and may process a command by providing the first memory area as a control buffer to a host device and loading mapping cache data corresponding to a part of the mapping data into a second auxiliary memory in a second operation mode, thereby providing a system capable of efficiently utilizing system resources and implementing artificial intelligence services while operating a large language model.

### CROSS-REFERENCE TO RELATED APPLICATIONS

The present application claims priority under 35 § U.S.C. 119(a) to Korean patent application number 10-2024-0045339 filed on Apr. 3, 2024, and Korean patent application number 10-2024-0094084 filed on Jul. 17, 2024 in the Korean Intellectual Property Office, which are incorporated herein by reference in its entirety.

### TECHNICAL FIELD

The embodiments of the present disclosure relate to a control device, a storage device, and a computing system.

### BACKGROUND

The operation, learning, and inference of large language models for the implementation of artificial intelligence services are being developed mainly in server environments equipped with high-performance memory resources. Recently, on-device artificial intelligence large language models are gradually expanding to provide artificial intelligence services in personal computer or mobile environments.

However, there is limited support of high-performance memory resources in personal computer or mobile environments, so the operation of on-device artificial intelligence in personal computer or mobile environments may be also very limited.

### SUMMARY

Embodiments of the disclosure may provide a method for running a large language model to provide artificial intelligence services on a personal computing device or a mobile device using a storage device.

Embodiments of the disclosure may provide a storage device including a memory, and a controller configured to load first data stored in the memory into a first memory area of a first auxiliary memory in a first operation mode, store at least a part of the first data loaded into the first memory area in the memory when receiving a control buffer use mode command from a host device, provide an access right to the first memory area to the host device, and control an operation of the memory according to a second operation mode.

Embodiments of the disclosure may provide a control device including a first auxiliary memory having a first storage capacity and including a first memory area and a second memory area, a second auxiliary memory having a second storage capacity smaller than the first storage capacity, and a core processor configured to load first data stored in an external memory into the first memory area in a first operation mode, to store the first data loaded into the first memory area in the external memory, and to load a first cache data corresponding to a part of the first data into the second auxiliary memory in a second operation mode.

Embodiments of the disclosure may provide a computing system including a storage device including a first volatile memory and a non-volatile memory, and a host device accessing the storage device and processing data, wherein the storage device is configured to load first data stored in the non-volatile memory into the first volatile memory, store the first data loaded into the first volatile memory into the non-volatile memory in response to a control buffer use mode command received from the host device, and provide an access right to at least a part of the first volatile memory to the host device.

According to embodiments of the present disclosure, it is possible to provide an artificial intelligence service through the running, inference and learning of a large language model in a computing system environment where the construction of high-performance memory resources is limited.

### BRIEF DESCRIPTION OF THE DRAWINGS

FIG. 1 illustrates a schematic configuration of a storage device according to embodiments of the present disclosure.

FIG. 2 illustrates an operation of a storage device in a first operation mode according to embodiments of the present disclosure.

FIG. 3 and FIG. 4 illustrate operations performed by a storage device in a second operation mode according to embodiments of the present disclosure.

FIG. 5 to FIG. 7 illustrate operations of a storage device and a host device in a second operation mode according to embodiments of the present disclosure.

FIG. 8 illustrates an example of operations of a storage device in a first operation mode and a second operation mode according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure rather more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompass all the meanings of the term “can”.

Hereinafter, various embodiments of the present disclosure will be described in detail with reference to accompanying drawings.

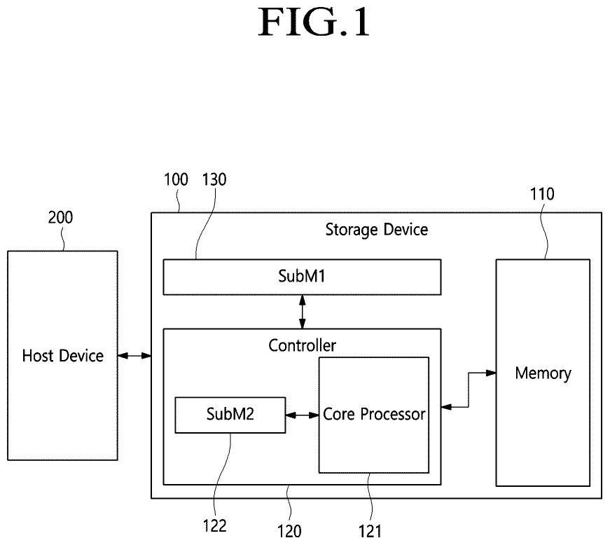

FIG. 1 illustrates a schematic configuration of a storage device according to embodiments of the present disclosure.

Referring to FIG. 1, a storage device 100 may include at least one memory 110. The storage device 100 may include a controller 120 for controlling the operation of the memory 110. The storage device 100 may include at least one first auxiliary memory 130 (SubM1) used for control operations of the controller 120.

The memory 110 may be, for example, a volatile memory such as DRAM, SDRAM, DDR SDRAM, and LPDDR SDRAM, but the memory 110 according to embodiments of the present disclosure is not limited thereto. The memory 110 may also be a non-volatile memory such as a NAND flash memory, a 3D NAND flash memory, and a NOR flash memory. In addition, some of the memory 110 included in the storage device 100 may be volatile memory, and other memory may be non-volatile memory.

In addition, the memory 110 may be one of various types of memory, such as a resistive memory (e.g., ReRAM), a phase-change memory, a magnetoresistive memory, a ferroelectric memory, or a spin transfer torque-magnetic memory (e.g., SST-MRAM). In addition, the memory 110 may be a processing-in-memory having an operation function or a data processing function, depending on the case.

The memory 110 may include a plurality of storage blocks. Each of the plurality of storage blocks may include a plurality of memory cells.

The controller 120 may receive a command from the outside and control the operation of the memory 110 based on the received command. In addition, the controller 120 may control the operation of the memory 110 based on a command generated internally. In this disclosure, a command received from the outside by the controller 120 may be referred to as an external command, and a command generated internally by the controller 120 may be referred to as an internal command.

The controller 120 may control the operation of the memory 110 based on an external command or an internal command. The controller 120 may control, for example, an operation of writing data to the memory 110. The controller 120 may control an operation of reading data written to the memory 110.

The controller 120 may control a data preservation operation (e.g., a refresh operation, a patrol scrub operation, etc.) or an erase operation for data written to the memory 110, depending on the type of the memory 110.

The controller 120 may control the operation of the memory 110 based on a command received from an external host device 200. The controller 120 may provide the host device 200 with a processing result according to an operation corresponding to the command. The controller 120 may transmit data or a response signal to the host device 200.

The host device 200 may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host device 200 may be a virtual reality (VR) device providing 2D or 3D virtual reality images or an augmented reality (AR) device providing augmented reality images. In addition to the examples described above, the host device 200 may be any one of various electronic devices that require a storage device 100 capable of storing data.

The host device 200 may include at least one operating system (OS). The operating system may generally manage and control the function and operation of the host device 200, and may control interoperability between the host device 200 and the storage device 100. The operating system may be classified into a general operating system and a mobile operating system depending on the mobility of the host device 200.

The host device 200 and the controller 120 may be separate devices. In some cases, the controller 120 and the host device 200 may be implemented as integrated into a single device, or some configurations or functions of the controller 120 may be implemented as included in the host device 200. Hereinafter, for convenience of explanation, examples assume that the controller 120 and the host device 200 are separate devices.

The controller 120 may perform a background operation related to the memory 110 based on an external command received from the host device 200 or based on an internal command in order to maintain and improve the operation performance of the storage device 100. The background operation may include, for example, one or more of garbage collection, wear leveling, read reclaim, or bad block management operations. The controller 120 may improve the operation performance of the storage device 100 or prevent the operation performance from deteriorating by controlling background operations.

The controller 120 may include various interfaces and processors to process commands from the host device 200 and control the operation of the memory 110. The controller 120 may include at least one working memory providing a data storage space required to perform the operations described above.

The controller 120 may include, for example, a core processor 121 that controls the overall operation of the controller 120. The controller 120 may include at least one second auxiliary memory 122 (SubM2) used as a working memory for a control operation. The core processor 121 and the second auxiliary memory 122 may, for example, be provided in the form of a single chip created by forming a control chip. The core processor 121 may perform a control operation by using a first auxiliary memory 130 located outside the controller 120 and the second auxiliary memory 122 located inside the controller 120. In this specification, the controller 120 and the first auxiliary memory 130 may be collectively referred to as a control device.

The core processor 121 may perform a function of processing a command received from the host device 200 or outputting a command for controlling the memory 110. The core processor 121 may, for example, run a firmware to perform various operations for control.

The core processor 121 may use at least one working memory to store various data required in the process of performing control. The core processor 121 may, for example, use the first auxiliary memory 130 and the second auxiliary memory 122.

The first auxiliary memory 130 and the second auxiliary memory 122 may be, for example, volatile memories. The first auxiliary memory 130 and the second auxiliary memory 122 may be the same type of memory or different types of memory. The first auxiliary memory 130 may be, for example, a DRAM, and the second auxiliary memory 122 may be an SRAM, but the embodiments of the present disclosure are not limited thereto.

The storage capacity of the first auxiliary memory 130 may be larger than the storage capacity of the second auxiliary memory 122.

The core processor 121 may use the storage space provided by the first auxiliary memory 130 and the second auxiliary memory 122, and may process a command of the host device 200 or control the operation of the memory 110 according to the command.

In addition, the core processor 121 may utilize at least one of the first auxiliary memory 130 or the second auxiliary memory 122 in various forms depending on the operation mode of the storage device 100.

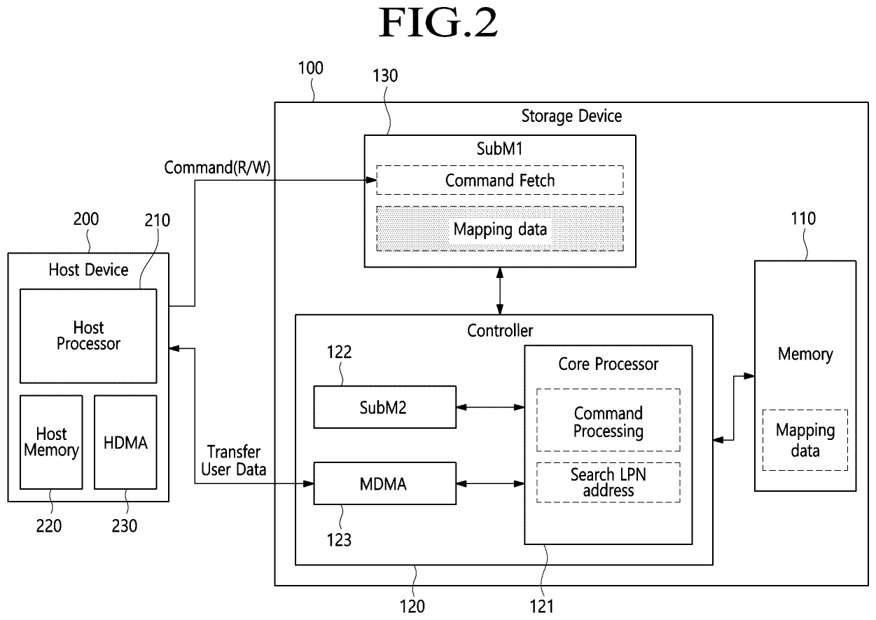

FIG. 2 illustrates an operation of a storage device in a first operation mode according to embodiments of the present disclosure.

Referring to FIG. 2, a storage device 100 may include a memory 110, a controller 120, and a first auxiliary memory 130. The controller 120 may include a core processor 121 and a second auxiliary memory 122. The core processor 121 may control the operation of the controller 120 and the memory 110. The first auxiliary memory 130 and the second auxiliary memory 122 may be volatile memories, and the storage capacity of the first auxiliary memory 130 may be larger than the storage capacity of the second auxiliary memory 122.

The controller 120 may include a direct memory access controller 123 (MDMA). The direct memory access controller 123 may, for example, control data transfer between the storage device 100 and a host device 200.

The controller 120 may receive a command from the host device 200 and control an operation of the storage device 100 according to the command.

The host device 200 may include, for example, a host processor 210, which controls the operation of the host device 200 and performs data processing. The host device 200 may include a host memory 220 and a host direct memory access controller 230 (HDMA).

The host processor 210 may control the operation of the host device 200 and data processing including various operations. The host processor 210 may also control, for example, the running, inference and learning operations of a large language model for providing an artificial intelligence service. The host processor 210 may provide artificial intelligence-based result data in response to a user's request by using the large language model.

The host memory 220 may be, for example, a volatile memory. The host memory 220 may be referred to as a local memory. The host processor 210 may perform data processing including the running, inference and learning of a large language model using the host memory 220.

The host direct memory access controller 230 may control data transmission between the host device 200 and the storage device 100.

The controller 120 of the storage device 100 may control the operation of the storage device 100 when the storage device 100 starts operating or receives a command from the host device 200. This control may be performed by the core processor 121, and in the following, the control performed by the core processor 121 may be described as being performed by the controller 120.

The storage device 100 may operate according to a first operation mode as a basic operation mode. The operation mode of the storage device 100 may be set based on a command transmitted by the host device 200, for example.

The controller 120 may, for example, load mapping data stored in the memory 110 into the first auxiliary memory 130 and process the command or control the operation of the storage device 100. The controller 120 may load the entire mapping data stored in the memory 110 into the first auxiliary memory 130, and in some cases, may load a part of the mapping data into the first auxiliary memory 130.

Mapping data may be data including mapping information between a logical block address (or logical page number LPN) provided by a host device 200 and a physical block address (or virtual page number) corresponding to a storage block included in a memory 110. The controller 120 may map a logical block address from a host device 200 and a physical block address of a memory 110, store user data corresponding to the logical block address in a storage area corresponding to the physical block address, and manage the user data.

The mapping data may be, for example, loaded into a first memory area of the first auxiliary memory 130. The first auxiliary memory 130 may include a first memory area and a second memory area.

The second memory area may mean at least a portion of an area other than the first memory area. The size of the first memory area may be larger than the size of the second memory area. The first memory area and the second memory area may mean physically distinct areas, or an area corresponding to a size allocated for loading mapping data from the first auxiliary memory 130 may be referred to as a first memory area, and the remaining area may be referred to as a second memory area.

The controller 120 may load mapping data into the first auxiliary memory 130 and process a command of the host device 200 based on the mapping data.

The controller 120 may, for example, check a logical block address according to the command when receiving a command from the host device 200. The controller 120 may check a physical block address corresponding to the logical block address using the mapping data and control a program operation or a read operation according to the command for a storage area indicated by the physical block address.

The host device 200 may request the storage device 100 to store or read data. The host device 200 may control an operation of running, inferring and learning a large language model for providing an artificial intelligence service using the internal resources of the host device 200. In this case, the user data stored in the storage device 100 may be loaded and the large language model may be run or driven.

For example, the host device 200 may transmit a read command, for user data for running a large language model, to the storage device 100.

The controller 120 of the storage device 100 may store the command received from the host device 200 in the first auxiliary memory 130. The controller 120 may control an operation of reading the user data requested by the host device 200 using the command and mapping data stored in the first auxiliary memory 130.

The core processor 121 of the controller 120 may perform an operation of processing a command by and an operation of searching a physical block address corresponding to a logical block address.

The controller 120 may control an operation of reading user data stored in a storage area of the memory 110 indicated by a physical block address, and may provide, to the host device 200, user data corresponding to a command of the host device 200. The operation of providing user data to the host device 200 may be performed by, for example, a direct memory access controller 123. The direct memory access controller 123 may provide, to the host device 200, user data according to a command of the host device 200.

The host device 200 may receive user data required for running a large language model from the storage device 100. The host device 200 may perform the operations of running, inferring, and learning for a large language model based on received user data. While running the large language model, the host device 200 may use the storage device 100 according to a first operation mode, and in some cases, may use the storage device 100 according to a second operation mode different from the first operation mode. In the second operation mode, the host device 200 may perform data processing by using at least a part of the resources included in the storage device 100.

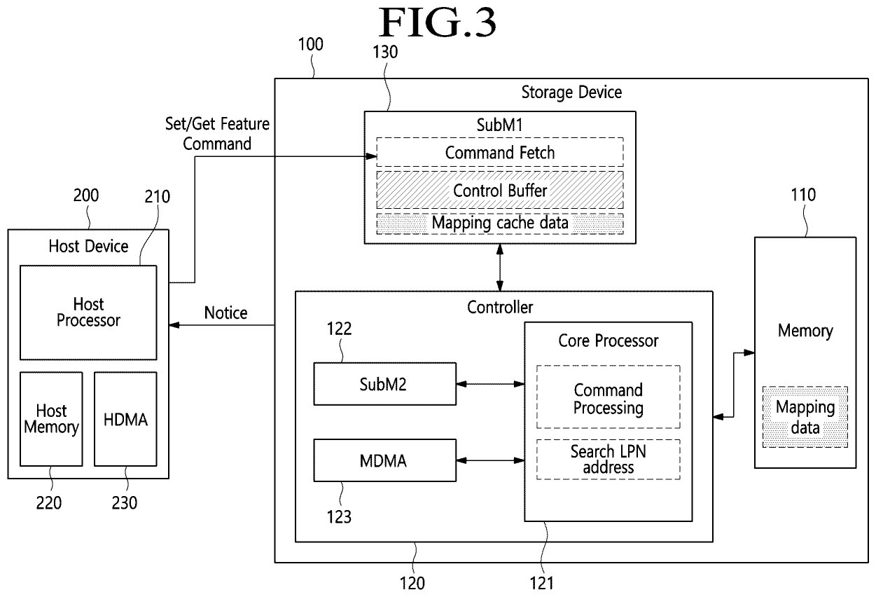

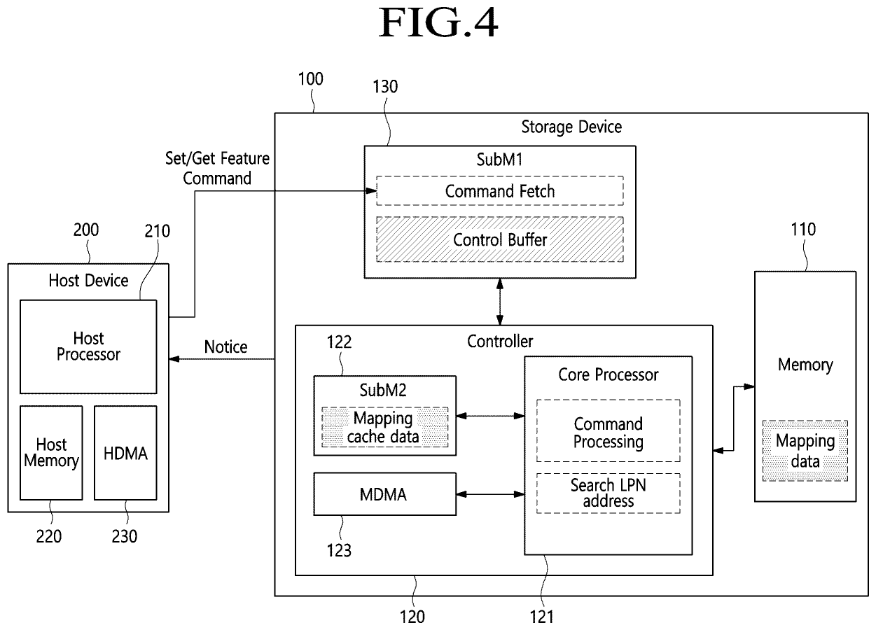

FIG. 3 and FIG. 4 illustrate operations performed by a storage device in a second operation mode according to embodiments of the present disclosure.

Referring to FIG. 3, in a second operation mode, a storage device 100 may receive a control buffer use mode command from a host device 200.

The control buffer use mode command may be, for example, a command requesting access by the host device 200 to at least a part of a first auxiliary memory 130 included in the storage device 100. In some cases, the control buffer use mode command may be a command requesting that the host device 200 use at least a portion of a memory 110 or a working memory included in the storage device 100, and may be a command requesting a function of a control memory buffer CMB defined in the NVMe standard.

The storage device 100 may operate according to the second operation mode upon receiving the control buffer use mode command from the host device 200. Alternatively, the storage device 100 may perform processing for operating in a first operation mode and then switch to the second operation mode.

In addition, the storage device 100 may check whether a second operation mode transition requirement is met, and may switch to the second operation mode. For example, the storage device 100 may check whether the control buffer use mode command is a command set for the second operation mode, and may perform a transition to the second operation mode. In addition, if the storage device 100 is processing a command received from the host device 200 before receiving the control buffer use mode command, the storage device 100 may perform a transition to the second operation mode after completing the processing of the command in the other mode. The storage device 100 may proceed with a transition to the second operation mode from an idle state. In addition, the storage device 100 may proceed with the transition to the second operation mode after checking whether there is no factor that hinders a transition to the second operation mode.

The controller 120 may store at least a part of the mapping data, loaded into a first memory area of the first auxiliary memory 130, in the memory 110 when receiving the control buffer use mode command. At least a part of the mapping data may be flushed to the memory 110.

The controller 120 may set a right access at least a part of the first memory area for the host device 200. The controller 120 may, for example, provide address information for at least a part of the first memory area to the host device 200.

The host device 200 may access at least a part of the first memory area of the first auxiliary memory 130 included in the storage device 100 based on the address information and perform data processing.

The host device 200 may control the data processing or the operation of a large language model by using the host memory 220 included in the host device 200 and the first auxiliary memory 130 included in the storage device 100. If the large language model is operated or run by the host device 200, then available memory resources may increase. The running of the large language model may be performed while efficiently utilizing the resources of the host memory 220 included in the host device 200.

The storage device 100 may process a command of the host device 200 by using mapping cache data after transmitting the mapping data to the memory 110 for the second operation mode. The mapping cache data may be data corresponding to a part of the mapping data stored in the memory 110.

The controller 120 may load the mapping cache data into a part of the first memory area of the first auxiliary memory 130, and may process a command of the host device 200 using the mapping cache data. The controller 120 may provide access to only a part of the first memory area of the first auxiliary memory 130 to the host device 200, and may set and use the other part as an area for loading the mapping cache data.

In other embodiments, the controller 120 may load the mapping cache data for operations into a second auxiliary memory 122 that is different from the first auxiliary memory 130.

For example, referring to FIG. 4, when receiving a control buffer use mode command from the host device 200, the controller 120 may store, in the memory 110, at least a part of the mapping data loaded into the first auxiliary memory 130. At least a part of the first memory area of the first auxiliary memory 130 may be used by the host device 200.

The controller 120 may load the mapping cache data, based on the mapping data stored in the memory 110, into the second auxiliary memory 122. The controller 120 may manage the mapping cache data by using the second auxiliary memory 122 without using the first auxiliary memory 130. The controller 120 may control an operation of processing a command by the host device 200 based on the mapping cache data loaded into the second auxiliary memory 122.

Since the mapping cache data is managed using a storage area of the second auxiliary memory 122, the first memory area of the first auxiliary memory 130 may not be used by the controller 120 in the second operation mode. If the entirety of the mapping data loaded into the first memory area of the first auxiliary memory 130 in the first operation mode is exported to the memory 110, then the entirety of the first memory area may be provided to the host device 200. As a result, the memory resources of the storage device 100 available for use by the host device 200 increases.

The controller 120 may transmit a control buffer use mode notification to the host device 200 when the host device 200 is enabled to access the first auxiliary memory 130 in response to the control buffer use mode command.

The host device 200 may perform data processing using at least a part of the first auxiliary memory 130, and the controller 120 may perform control of the memory 110 using an area of the first auxiliary memory 130, which is not accessed by the host device 200 or the second auxiliary memory 122. In addition, while embodiments of the present disclosure exemplarily describe controller 120 providing the host device 200 with a first memory area for storing mapping data from among the memory areas of the first auxiliary memory 130, in other embodiments the controller 120 may also provide the host device 200 with a memory area for storing data other than mapping data. For example, an area in the first auxiliary memory 130 may be provided to the host device 200 for storing first data. The first data may include the mapping data as described, or may include other types of data or meta data other than the mapping data.

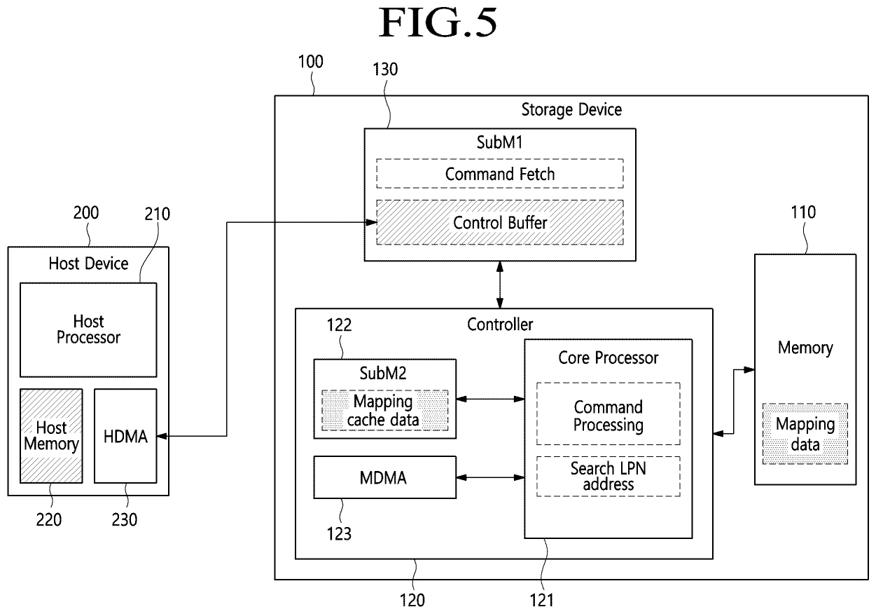

FIG. 5 to FIG. 7 illustrate operation of a storage device and a host device in a second operation mode according to embodiments of the present disclosure. The examples described below are based on an example described in FIG. 4, but may also be applied equally to an example described in FIG. 3.

Referring to FIG. 5, in a second operation mode, the state of a storage device 100 may include mapping data is stored in a memory 110. A controller 120 may load mapping cache data, corresponding to a part of the mapping data stored in the memory 110, into a second auxiliary memory 122 for use in the second operation mode.

At least a part of a first memory area of a first auxiliary memory 130 may be available to a host device 200. The entire first memory area of the first auxiliary memory 130 may be accessible to the host device 200.

The host device 200 may perform data processing by using a host memory 220 included in the host device 200 and the first memory area of the first auxiliary memory 130 provided by the storage device 100. Hereinafter, the first memory area provided from the first auxiliary memory 130 to the host device 200 may be referred to as a control buffer.

The host device 200 may access the control buffer using a host direct memory access controller 230. The host direct memory access controller 230 may perform an operation of copying data to the control buffer or reading data written to the control buffer.

The host device 200 may perform data processing using the host memory 220 and the control buffer, and the host memory 220 and the control buffer may be used for the same purpose or for different purposes.

For example, the host device 200 may use the control buffer for the same purpose as the host memory 220. The host device 200 may store and read data in the control buffer, in a manner similar to storing data in and reading data from the host memory 220.

The host device 200 may perform data processing in view of the available storage capacity, which has a size of the storage capacity of the host memory 220 increased by the storage capacity of the control buffer. When the host device 200 performs data processing requiring high-performance memory resources, such as running, inference and learning of a large language model, it is possible to improve the performance of data processing when the host device operates by using the control buffer of the storage device 100.

In other embodiments, the host device 200 may use the control buffer for a purpose that is different from the purpose of using the host memory 220.

For example, if the host device 200 performs running, inference, and learning of a large language model, the host device 200 may store and manage the result data provided to the user through the running of the large language model while using the host memory 220. The host device 200 may store and manage the data used for updating the large language model as the result data according to the learning of the large language model in the control buffer.

The host device 200 may manage the result data, which is directly provided to the user according to the running of the large language model, through the host memory 220, and may manage the result data, which is used for updating through learning the large language model and used at time intervals, through the control buffer.

The storage capacity of the host memory 220 may be supplemented through the control buffer. In addition, data management may be performed considering the difference in delay time (e.g., latency difference) between the host processor 210 and the host memory 220 and the difference in delay time (e.g., latency difference) between the host processor 210 and the control buffer.

The controller 120 of the storage device 100 may process a command of the host device 200 and control the operation of the memory 110 by using a part of the first auxiliary memory 130 and the second auxiliary memory 122 while providing the control buffer to the host device 200.

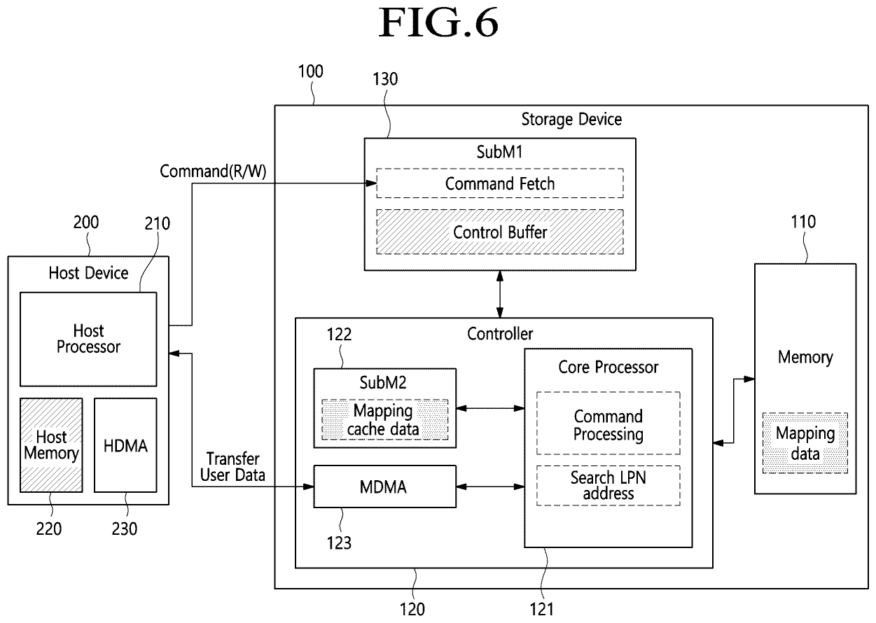

For example, referring to FIG. 6, the storage device 100 may provide an area corresponding to at least a part of a first memory area of the first auxiliary memory 130 as a control buffer to the host device 200 in a second operation mode.

In the second operation mode, a core processor 121 of the controller 120 may not access the first memory area corresponding to the control buffer. The core processor 121 may access a second memory area other than the first memory area in the first auxiliary memory 130.

The second memory area may be, for example, an area where the controller 120 stores meta data, commands, and so on required to control the memory 110 in addition to mapping data.

The core processor 121 may control the operation of the memory 110 by accessing the second memory area without accessing the first memory area provided as a control buffer in the second operation mode.

As an example, the controller 120 may receive a command from the host device 200. The host device 200 may transmit a command to write data to the storage device 100 or a command to read data from the storage device 100 while running a large language model.

The core processor 121 of the controller 120 may store a command received from the host device 200 in an area other than the first memory area of the first auxiliary memory 130. The core processor 121 may use a mapping cache data loaded into the second auxiliary memory 122 to check the physical block address mapped to a logical block address according to the command of the host device 200.

If the core processor 121 cannot check the physical block address using the mapping cache data loaded into the second auxiliary memory 122, then the core processor 121 may load the mapping cache data corresponding to another part of the mapping data stored in the memory 110 into the second auxiliary memory 122, and then check a physical block address mapped to the logical block address according to the command of the host device 200.

The core processor 121 may check the physical block address and process the command of the host device 200. Depending on the command from the host device 200, user data may be written to the memory 110, or the user data written to the memory 110 may be provided to the host device 200.

If a command by the host device 200 is a read command, then user data corresponding to the read command may be directly provided to the host device 200 by the memory access controller 123.

The host device 200 may transmit a command to the storage device 100 as needed while running a large language model using the control buffer provided from the storage device 100 to request data processing corresponding to the command. The host device 200 may access the control buffer through the host direct memory access controller 230, and the storage device 100 may access the host device 200 through the direct memory access controller 123.

The command by the host device 200 may be processed in the second operation mode, in which the first memory area of the first auxiliary memory 130 is used as the control buffer by the host device 200.

The controller 120 of the storage device 100 may control the storage device 100 by using an area other than the first memory area of the first auxiliary memory 130 and the second auxiliary memory 122 while operating in the second operation mode.

The controller 120 may stop providing the control buffer when receiving a control buffer usage release command from the host device 200. The storage device 100 can switch from operating in the second operation mode to operating in the first operation mode.

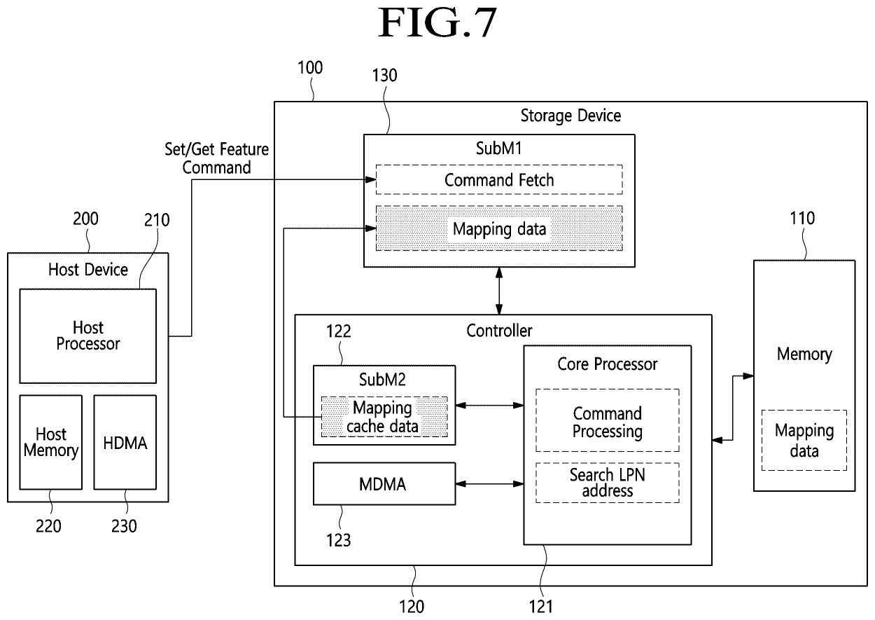

For example, referring to FIG. 7, the host device 200 may transmit a control buffer usage release command to the storage device 100 when use of the control buffer provided from the storage device 100 is completed.

The controller 120 of the storage device 100 may release the right of the host device 200 to access the first memory area of the first auxiliary memory 130 when the control buffer usage release command is received. The controller 120 may switch or transition from the second operation mode to the first operation mode.

The controller 120 may load the mapping data stored in the memory 110 into the first memory area of the first auxiliary memory 130. The controller 120 may update the mapping data loaded into the first memory area of the first auxiliary memory 130 using the mapping cache data loaded into the second auxiliary memory 122.

While operating in the second operation mode, the mapping data may be updated based on the mapping cache data modified according to the command of the host device 200.

The controller 120 may control the operation of the memory 110 according to a command of the host device 200 in a state in which the mapping data is loaded in the first memory area of the first auxiliary memory 130.

The controller 120 may control the storage device 100 using the first auxiliary memory 130 until a new request from the host device 200 occurs. When a new request from the host device 200 occurs, the controller 120 may provide a part of the first auxiliary memory 130 to the host device 200 as a control buffer to improve the operation performance of the host device 200.

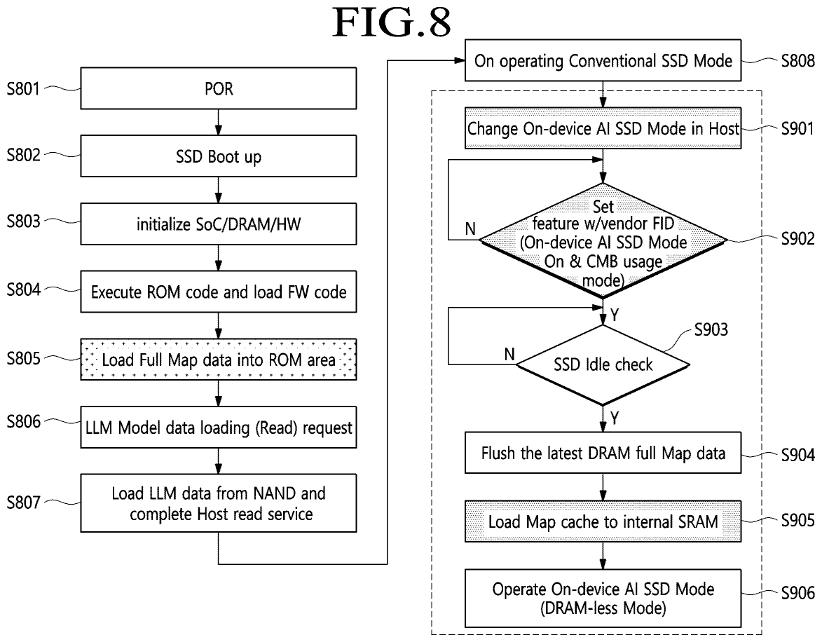

FIG. 8 illustrates operations of a storage device in a first operation mode and a second operation mode according to embodiments of the present disclosure.

Referring to FIG. 8, power to a storage device 100 is turned on (S801) by a POR (Power On Reset) signal, and a storage device 100 (e.g., Solid State Drive, SSD) may be booted (S802). The storage device 100 including a controller 120 (e.g., System On Chip, SoC) and a first auxiliary memory 130 (e.g., DRAM) may be initialized (S803). The controller 120 may load ROM code and firmware (FW) code stored in a memory 110 and the like (S804).

When starting an operation of the storage device 100, the storage device 100 may operate in a first operation mode.

The controller 120 may load all of the mapping data (Map data) stored in the memory 110 into the first auxiliary memory 130 (S805). The mapping data may be loaded, for example, into a first memory area (e.g., ROM area) of the first auxiliary memory 130.

The controller 120 may receive a request for loading data of a large language model (LLM) from a host device 200 (S806). The controller 120 may receive a request for loading user data stored in the storage device 100 as the data for running the large language model (LLM) of the host device 200.

The controller 120 may read the user data stored in the memory (e.g., NAND) 110 and provide the user data to the host device 200 based on the mapping data loaded into the first auxiliary memory 130 and the command received from the host device 200 (S807).

The controller 120 may process a command from the host device 200, and may operate in the first operation mode (e.g., Conventional SSD Mode) until a separate request is received (S808).

The host device 200 may change an operation mode (e.g., On-device AI SSD Mode). The controller 120 may receive a control buffer use mode (e.g., On-device AI SSD Mode) command from the host device 200 (S901).

The control buffer use mode command may be a command requesting the use of a portion of a memory area in the storage device 100. The control buffer use mode command may be a command requesting a change or a transition of the operation mode of the storage device 100. The control buffer use mode command may be a command requesting or instructing the operation of a control memory buffer (CMB) defined in the NVMe standard.

When receiving the control buffer use mode command, the controller 120 may check whether the control buffer use mode command corresponds to a command preset between the host device 200 and the storage device 100 (S902).

If the control buffer use mode command corresponds to a preset command, then the controller 120 may check whether the storage device 100 is in an idle state (S903). An idle state may mean a state in which processing of a command previously received from the host device 200 is completed.

If the storage device 100 is in an idle state, the controller 120 may flush the mapping data (Map data) loaded into the first auxiliary memory (DRAM) 130 to the memory 110 (S904).

The controller 120 may load the mapping cache data, corresponding to a portion of the mapping data flushed into the memory 110, into the second auxiliary memory 122 (SRAM) (S905).

The controller 120 may operate in the second operation mode (e.g., On-device AI SSD Mode) when the flush operation for the first auxiliary memory 130 and the loading operation of the mapping cache data to the second auxiliary memory 122 are completed (S906).

At least a part of the memory area that was used for loading the mapping data from the first auxiliary memory 130 by the controller 120 may be provided to the host device 200 as a control buffer. The host device 200 may perform data processing using the host memory 220 and the control buffer of the storage device 100.

The host device 200 may perform, for example, the running, inference, and learning operations of a large language model using the control buffer. In addition, when the use of the control buffer is completed, the host device 200 may transmit a control buffer usage release command to the storage device 100.

The controller 120 of the storage device 100 may not access the first memory area of the first auxiliary memory 130 until receiving a control buffer usage release command, and may control the storage device 100 by using a memory area other than the first memory area of the first auxiliary memory 130.

The controller 120 may control the storage device 100 by switching to a first operation mode according to a command of the host device 200 while operating in the second operation mode. The operation of the controller 120 switching from the second operation mode to the first operation mode may be performed in reverse, i.e., in an opposite manner to the operation of switching from the first operation mode to the second operation mode.

The controller 120 may receive a control buffer usage release command from the host device 200 while operating in the second operation mode. The host device 200 may terminate the use of the first memory area of the first auxiliary memory 130 included in the storage device 100, and may transmit the control buffer usage release command to the storage device 100.

When receiving the control buffer usage release command, the controller 120 may check whether there is a command being processed. If it is confirmed that there is no command being processed and it is in an idle state, the controller 120 may clear an area corresponding to the control buffer of the first auxiliary memory 130 provided to the host device 200.

The controller 120 may load mapping data stored in the memory 110 into the first auxiliary memory 130. The controller 120 may transmit a signal to the host device 200 to notify that the transition or the switching to the first operation mode is completed. The controller 120 may load mapping data into the first auxiliary memory 130 and use the mapping data until receiving a new control buffer use mode command from the host device 200, and may use the first auxiliary memory 130 for controlling operations of the memory 110.

According to embodiments of the present disclosure, a storage device 100 may have a function of storing data, and if necessary, a control buffer may be provided to a host device 200. Accordingly, when performing data processing operations such as a large language model, it is possible to efficiently use the resources of the host device 200, and improve performance when providing an artificial intelligence service by the host device 200.

Based on embodiments of the disclosed technology described above, the operation delay time of the memory system may be advantageously reduced or minimized. In addition, according to embodiments of the disclosed technology, an overhead occurring in the process of calling a specific function may be advantageously reduced or minimized. Although various embodiments of the disclosed technology have been described with particular specifics and varying details for illustrative purposes, those skilled in the art will appreciate that various modifications, additions and substitutions may be made based on what is disclosed or illustrated in the present disclosure without departing from the spirit and scope of the invention as defined in the following claims.

What is claimed is:

1. A storage device comprising:
a memory; and
a controller configured to,
load first data stored in the memory into a first memory area of a first auxiliary memory in a first operation mode,
store at least a part of the first data loaded into the first memory area in the memory when receiving a control buffer use mode command from a host device,
provide an access right to the first memory area to the host device, and
control an operation of the memory according to a second operation mode.

2. The storage device of claim 1, wherein the controller stores the first data in the memory and then loads a first cache data, corresponding to a part of the first data, into a second auxiliary memory separate from the first auxiliary memory.

3. The storage device of claim 2, wherein the controller loads the first data stored in the memory into the first memory area of the first auxiliary memory when receiving a control buffer usage release command from the host device.

4. The storage device of claim 3, wherein the controller updates the first data loaded into the first memory area of the first auxiliary memory using the first cache data loaded into the second auxiliary memory.

5. The storage device of claim 1, wherein the controller stores the first data in the memory and then loads a first cache data, corresponding to a part of the first data, into another part of the first auxiliary memory.

6. The storage device of claim 1, wherein the controller controls the operation of the memory by using a second memory area other than the first memory area of the first auxiliary memory in the second operation mode.

7. The storage device of claim 1, wherein the controller does not access the first memory area of the first auxiliary memory in the second operation mode and accesses a second memory area other than the first memory area of the first auxiliary memory.

8. The storage device of claim 1, wherein the controller stores at least a part of the first data loaded into the first memory area, in the memory in an idle state after receiving the control buffer use mode command.

9. The storage device of claim 1, wherein the controller provides address information of at least a part of the first memory area to the host device.

10. The storage device of claim 1, wherein the controller transmits a control buffer use mode notification to the host device when entering the second operation mode.

11. The storage device of claim 1, wherein, in the second operation mode, the first memory area of the first auxiliary memory is accessed by a host direct memory access controller included in the host device.

12. A control device comprising:
a first auxiliary memory having a first storage capacity and including a first memory area and a second memory area;
a second auxiliary memory having a second storage capacity smaller than the first storage capacity; and
a core processor configured to load first data stored in an external memory into the first memory area in a first operation mode, to store the first data loaded into the first memory area in the external memory, and to load a first cache data corresponding to a part of the first data into the second auxiliary memory in a second operation mode.

13. The control device of claim 12, wherein the core processor accesses the second memory area without accessing the first memory area in the second operation mode.

14. The control device of claim 12, wherein an externally located processor accesses the first memory area of the first auxiliary memory in the second operation mode.

15. The control device of claim 12, wherein, when switching from the second operation mode to the first operation mode, the core processor loads the first data stored in the external memory into the first memory area of the first auxiliary memory, and updates the first data using the first cache data loaded into the second auxiliary memory.

16. The control device of claim 12, wherein the core processor and the second auxiliary memory are located inside a control chip, and the first auxiliary memory is located outside the control chip.

17. A computing system comprising:
a storage device including a first volatile memory and a non-volatile memory; and
a host device accessing the storage device and processing data,
wherein the storage device is configured to load first data stored in the non-volatile memory into the first volatile memory, store the first data loaded into the first volatile memory into the non-volatile memory in response to a control buffer use mode command received from the host device, and provide an access right to at least a part of the first volatile memory to the host device.

18. The computing system of claim 17, wherein the storage device stores the first data in the non-volatile memory and then loads a first cache data corresponding to a part of the first data into a second volatile memory different from the first volatile memory.

19. The computing system of claim 18, wherein, when receiving a control buffer usage release command from the host device, the storage device loads the first data stored in the non-volatile memory into the first volatile memory, and updates the first data loaded into the first volatile memory using the first cache data loaded into the second volatile memory.

20. The computing system of claim 19, wherein the host device performs data processing using a host memory included in the host device and the non-volatile memory during at least a portion of a period between a time of transmitting the control buffer use mode command and a time of transmitting the control buffer usage release command.
